(19) United States
(12) Patent Application Publication
(10) Pub. No.: US 2005/0188266 A1
(43) Pub. Date: Aug. 25, 2005

(54) System and method using a programmable device for capturing signals from a device during testing

(76) Inventors: Brian Johnson, Allen, TX (US); Glen Edwards, Dallas, TX (US); Stuart C. Haden, Lucas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/765,581

(22) Filed: Jan. 27, 2004

(51) Int. Cl. G06F 11/00

(52) U.S. Cl. 714/30

(57) ABSTRACT

According to at least one embodiment, a system comprises a first device arranged on a circuit board. The system further comprises a programmable capture device arranged on the circuit board, wherein at least one input pin of the programmable capture device is communicatively coupled to at least one signal pin of the first device such that the programmable capture device captures at least one signal from the first device during testing of the first device.

### BACKGROUND

Once devices, such as integrated circuits, are manufactured, they typically undergo testing to ensure that they function as desired. A portion of the aforementioned testing often involves probing and analysis of signal patterns generated during operation of the devices. For instance, various integrated circuits, such as Application-Specific Integrated Circuits (“ASICs”) may be manufactured and implemented on a circuit board. Once the circuit board is complete, the integrated circuit(s) arranged thereon may have their functionality tested, and the use of probing technology allows the signal's patterns generated during operation of the circuit(s) to be validated.

Typically, a logic analyzer is used for observing the states and transitions of the input and output signals of an integrated circuit. As is well known, a logic analyzer may capture the signals of the integrated circuit to determine whether the state, transitions, and timing of the signals are as expected. Thus, the logic analyzer interfaces with the integrated circuit under test to capture signals for these determinations to be made.

Various techniques are available for interfacing a logic analyzer with an integrated circuit under test. Typically, a conductive trace is provided on the circuit board from selected input and output pins of an integrated circuit, with which the logic analyzer is to interface during probing, to connector(s) on the circuit board specifically used for interfacing with the logic analyzer's connectors. For instance, the logic analyzer typically includes one or more cables (e.g., six-foot long cables) each having one end coupled to the logic analyzer and having the opposite end coupled directly to the observation connectors on the circuit board. The logic analyzer observes and captures input and output signals of the integrated circuit under test during operation via this interface. More specifically, during directed circuit operation, the logic analyzer allows the capture of input and output signals supplied via its interface with the circuit board to allow for the verification of state, transition, and timing compliance to the original intent of the design.

In view of the above, a logic analyzer that interfaces with one or more connectors on the circuit board that are communicatively coupled (via conductive traces) to input/output pins of a device under test (DUT) (e.g., an integrated circuit implemented on the circuit board) is typically used for probing the DUT. The logic analyzer receives and captures the input and output signals of the DUT via the logic analyzer's interface connectors. During a typical probing operation, the input and output signals of the DUT are captured by the logic analyzer via its interface with the circuit board. The logic analyzer allows evaluation of the captured signals for determining whether the DUT is functioning as desired.

Traditional probing techniques use the logic analyzer to capture data as it is generated, which generally requires that the sampling frequency of the logic analyzer equal or exceed the operational frequency of the DUT. Logic analyzers are generally very expensive, and are generally considered capital equipment. Once logic analyzers that operate at a given frequency are acquired by a company, the company typically desires to utilize those logic analyzer(s) as long as possible before purchasing new equipment. However, through product development to meet consumer desires/demands, the operational speeds of devices that are to be probed often increase beyond the operational frequency of the logic analyzer more rapidly than the company would like to acquire such equipment. Thus, in some instances, a DUT may be run at a slower speed than its normal operating speed during probing to enable a slower logic analyzer to be utilized for the probing. However, such testing is not truly indicative of the DUT's normal operation and may fail to detect errors that arise when the DUT is operating at its normal operating speed (e.g., frequency-related errors). Often an error occurs at a higher frequency, but when the frequency is lowered to allow a lower operating speed logic analyzer to be used to observe the failure, the error vanishes, making it difficult to observe the event.

Further, in order to provide a suitable interface for the logic analyzer, one or more connectors are typically arranged on the circuit board and conductive traces are used to communicatively couple input/output pins of the DUT that are to be used during probing to the connectors for interfacing with the logic analyzer. Routing the signals from the DUT to such devices results in several problems. First, depending on how closely the connectors can be arranged to the DUT, the signals of one or more pins of the DUT may be routed an undesirably long distance on the circuit board. The longer such signals are routed before being captured, the more its signal quality may diminish. Further, the logic analyzer generally has relatively lengthy cables (e.g., 6-foot long cables) along which the output data travels before being captured by the logic analyzer. Thus, the integrity of the output data may further diminish before it is captured by the logic analyzer.

Another problem associated with routing signals from the DUT to connectors on the circuit board for interfacing with a logic analyzer is the complexity of the routing that often arises. Particularly for high pin-out devices that are to be probed, arranging the conductive traces on the circuit board for routing input and output data between connectors arranged on the board and the appropriate pins of the device may be very complex. For instance, many ASICs have a large number of pins (e.g., one-thousand, two-thousand, or more), and as the ASICs are made increasingly smaller, the large number of pins are densely populated in a relatively small area. Accordingly, difficulty arises in routing data between one or more connectors arranged on the circuit board and a large number (e.g., all) of the pins of such a DUT. Also, inclusion of such a large number of traces and connectors for probing a DUT may undesirably consume real estate on the circuit board that is useful only in probing. Even if the escape from the high-pin out DUT is performed, the logic analyzer headers require a relatively high amount of board real estate per signal they can accept. Because a high number of signals may be produced by a single device, a crowding effect may be encountered where a cluster of logic analyzer connection points spiral out from the DUT. Where there is a large number of signals to be probed, and they cannot be packed relatively tightly on the board, the trace length to escape from the DUT to the connector for the logic analyzer header becomes long, ultimately contributing to a degraded signal at the point where the logic analyzer samples the signal. Additionally, this long stub from the DUT to the logic analyzer header can have deleterious effects upon the performance of the DUT in system.

Traditional probing techniques typically include a route between connectors on the circuit board (that are used for interfacing with a logic analyzer) and selected ones of input/output pins of the DUT. As described above, in high pin-out DUTs, the routing of signals to/from all of the pins of the DUT may be difficult, and so in some instances only certain pre-selected pins are coupled to an interface connector. Additionally, the routing to and presence of logic analyzer interface connectors can cause a number of undesirable signal integrity issues on the original circuit as the topology of the original net has been significantly altered. In such case, only the inputs/outputs for the pre-selected pins may be observed during testing. Thus, the flexibility available during testing is limited.

### SUMMARY

According to at least one embodiment, a system comprises a first device arranged on a circuit board. The system further comprises a programmable capture device arranged on the circuit board, wherein at least one input pin of the programmable capture device is communicatively coupled to at least one signal pin of the first device such that the programmable capture device captures at least one signal from the first device during testing of the first device.

According to at least one embodiment, a method comprises triggering testing of a first device arranged on a circuit board. The method further comprises capturing data from the first device during the testing by a field-programmable data capture device arranged on the circuit board.

According to at least one embodiment, a system comprises a first means for performing an operation, wherein the first means is arranged on a circuit board. The system further comprises a means, arranged on the circuit board, for capturing signals from the first means during testing of the first means, wherein the capturing means is programmable while arranged on the circuit board.

### BRIEF DESCRIPTION OF THE DRAWINGS

FIG. 1 shows an example implementation of an embodiment for capturing signals from a device under test;

FIG. 2 shows an example of configuring a field-programmable capture device for capturing an output data signal in the center of the data eye;

FIGS. 3-5 show various example implementations that enable output data to be captured from a DUT and be communicated to a logic analyzer when the operational frequencies of the DUT and the logic analyzer are not the same;

FIG. 6 shows an example implementation of a field-programmable capture device (e.g., FPGA) for capturing data on both the rising and falling edges of a clock signal;

FIG. 7 shows an example operational flow diagram of an embodiment for using a programmable device for capturing signals from a device under test; and

FIG. 8 shows another example operational flow diagram of certain embodiments.

### DETAILED DESCRIPTION

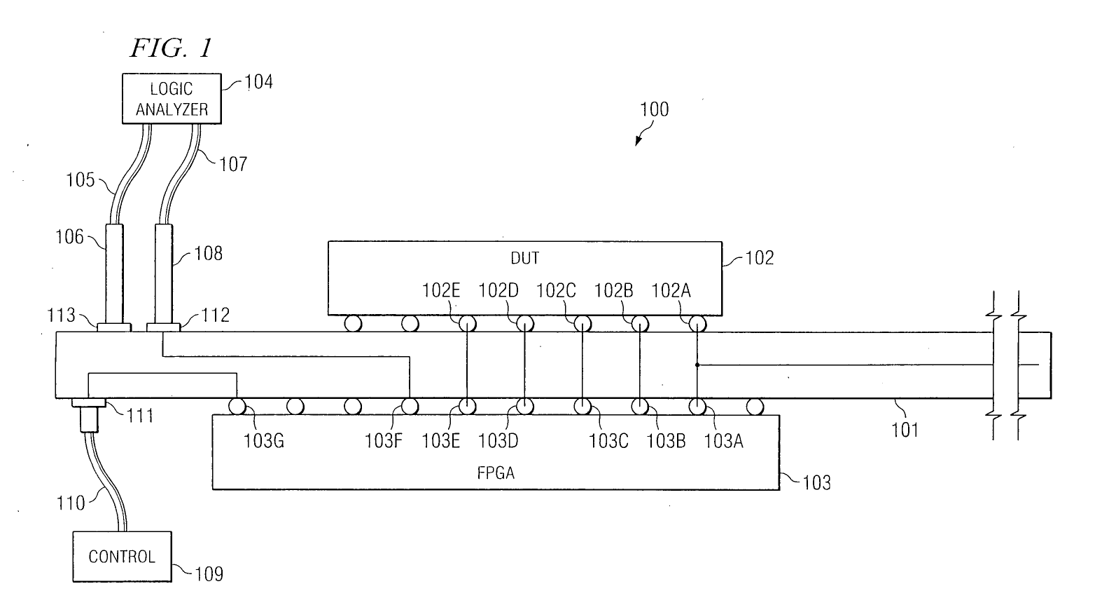

Turning to FIG. 1, an example implementation of an embodiment for using a programmable device to capture signals from a DUT is shown. FIG. 1 shows a system 100 for probing a DUT (e.g., an ASIC) 102 that is arranged on a circuit board 101. FIG. 1 shows a cross-sectional view of DUT 102, circuit board 101, and a capture device, shown here as Field Programmable Gate Array (FPGA) 103. An FPGA 103 of an embodiment is an integrated circuit that can be programmed in the field after manufacture. DUT 102 may be implemented on circuit board 101 along with various other devices. In this example, the aforementioned capture device, is included for capturing input/output signals (which may be referred to herein as “data”) on DUT 101 during normal circuit operation. FPGA 103 of the illustrated embodiment may be coupled to circuit board 101 via any suitable means, including solder, conductive adhesives, or mechanical connection, as examples. Such FPGA 103 is preferably arranged in a manner that minimizes the length of routing of signals from the pins of DUT 102 to the pins of FPGA 103. In the example implementation of FIG. 1, such FPGA 103 is arranged on a side of circuit board 101 opposite the side of circuit board 101 on which DUT 102 is arranged.

Because FPGA 103 may provide attachment points (pins) comparable in density to those of DUT 102, the arrangement of pins on FPGA 103 may coincide nicely with the arrangement of pins on DUT 102. Thus, the distance each signal present on pins of DUT 102 travels before being received by FPGA 103 is minimized, which in turn, minimizes the signal quality degradation that results from the presence of the observation point, such as the observation points 112 and 113 described below. For instance, in the example of FIG. 1, pins 102A-102E of DUT 102 are communicatively coupled to pins 103A-103E of FPGA 103. Thus, for instance, FPGA 103 may capture data input to such pins 103A-103E. FPGAs are available or may be made in a wide variety of packages, and their input/output (I/O) pin configurations are programmable such that an FPGA having a similar pin arrangement as a DUT may be selected for use in probing such DUT in the manner described herein.

In certain embodiments, the density of the input pins of FPGA 103 closely corresponds to the density of the input pins of DUT 102, which enables the length of trace from a signal pin of DUT 102 to the corresponding pin on FPGA 103 to minimize the diminishment in the signal's integrity. This is a function of the rise time of the signals in the system, wherein the faster the rise time, the closer the correspondence desired between the density of the input pins of FPGA 103 and the density of the signal pins of DUT 102. In certain embodiments, the density of input pins available on FPGA 103 for capturing signals from DUT 102 are on the order of the density of the signal pins of interest on such DUT 102. To reduce routing complexity (particularly for high pin-out DUTs), in certain embodiments the overall density of input pins of FPGA 103 is at least equal to the overall density of the signal pins of interest on DUT 102.

An external logic analyzer 104, which may correspond to a traditional logic analyzer, may be used for probing DUT 102. Logic analyzer 104 may include cables, such as cables 105 and 107, having headers (or probes or connectors) 106 and 108 for interfacing with circuit board 101. One or more interface receptacles, such as provided by observation points 112 and 113 in the example of FIG. 1, may be included on board 101 for interfacing FPGA 103 with logic analyzer 104. In the example of FIG. 1, observation point 112 is communicatively coupled to pin 103F of FPGA 103. Thus, logic analyzer 104 may capture data present on pin 103F of FPGA 103 via the interface with connector 112 for verifying the functionality of DUT 102. While only two observation points 112 and 113 are shown in the example of FIG. 1 (and while a trace to a pin of FPGA 103 is shown for only one of those connectors for simplification) any number of connectors for interfacing FPGA 103 with logic analyzer 104 (e.g., in a manner similar to that described for interfacing pin 103F of FPGA 103 with logic analyzer 104 via observation point 112) may be included in alternative implementations.

FPGA 103 is field programmable in the illustrated embodiment, which offers several advantages, as discussed further below. For instance, as shown in the example of FIG. 1, a control system 109 (e.g., personal computer or other processor-based device) may communicatively couple with FPGA 103 for programming or reprogramming FPGA 103 as desired. As shown, one or more interface points (e.g., connectors), such as header receptacle 111 in the example of FIG. 1, may be included on circuit board 101 for interfacing FPGA 103 with control system 109 (e.g., via cable 110). In the example of FIG. 1, header receptacle 111 is communicatively coupled to pin 103G of FPGA 103. Thus, control system 109 may supply control signals to pin 103G of FPGA 103 via a predefined interface with receptacle 111 for programming FPGA 103. While only one receptacle 111 and one FPGA pin 103G are shown in the example of FIG. 1 for simplification, any appropriate number of connections and FPGA pins may be used for the programming interface between FPGA 103 and control system 109.

Given that FPGA 103 can provide a dense array of connections on the order of that provided on DUT 102 (which may be a high pin-out grid-array device, such as an ASIC having 1,000 or more pins), the length of distance that signals travel from a signal pin of DUT 102 before being received by FPGA 103 can be minimized by essentially mirroring FPGA 103 on an opposite side of circuit board 101 from DUT 102, as shown in FIG. 1. In effect, FPGA 103 may be used to receive data from DUT 102 at as close a point as possible, thus resulting in optimal signal integrity. Rather than supplying a degraded signal to logic analyzer 104 for registration at many multiples of a desired distance from the initial trace, FPGA 103 of the illustrated embodiment handles registration initially, and then passes it to logic analyzer 104 for registration on a later (e.g., subsequent) clock cycle. Thus, in this example implementation, the reception of data by logic analyzer 104 may be consistently delayed by one or more clock cycles. Signal integrity from the analyzer's standpoint also becomes a non-issue since it will receive a point-to-point signal specifically intended for probing on output pin(s), such as pin 103F, of FPGA 103.

In certain embodiments, the integrity of the captured signals are not diminished before being captured by the FPGA, and thus the integrity of the signals received at the logic analyzer are of good quality. The loss of a digital signal is subject to all elements in the path until it is registered, and by having its input pins arranged relatively close to the signal pins of the DUT an FPGA captures the DUT's signals early in their path. The issue of signal diminishment is not problematic for the transfer from the FPGA over the cable to the logic analyzer because this is a point-to-point topology and the logic analyzer is the only receiver of the signal, thus making this an easy net for a single driver from the FPGA to drive. However, passively tapping off a signal from a DUT and passing this already attenuated signal back to the logic analyzer (as is attempted in many traditional testing techniques) with sufficient signal integrity is difficult. In effect, the FPGA acts as a repeater in certain implementations, capturing a signal from the DUT where it is still easy to correctly sample, stepping up the drive strength and conveying a strong copy of the signal up to the logic analyzer.

Because the signals captured from DUT 102 can be stored by FPGA 103 and later supplied to logic analyzer 104, the illustrated implementation allows greater flexibility regarding the operational frequency of the logic analyzer that is used for probing DUT 102. For instance, if the operational frequency of logic analyzer 104 differs from the operational frequency of DUT 102, in certain implementations DUT 102 may still be probed at its operational frequency, as is generally desired (e.g., to enable detection of frequency-related errors, etc.), and FPGA 103 may be used to capture full-frequency signals from DUT 102, provide a temporary storage buffer for those signals, and supply those signals to logic analyzer 104 at a suitable data rate (or frequency).

Also, because of the reprogrammable nature of FPGA 103, the signals that are captured by FPGA 103 and/or the subsequent signals that are output to logic analyzer 104 may be changed, re-formatted, filtered and/or otherwise logically manipulated (e.g., the selection of signals that are captured by FPGA 103 and/or the selection of signals that are output to logic analyzer 104 may be altered even after the manufacture of board 101 is complete). For instance, the specific input/output pins of FPGA 103 that are to be received in a given test may be dynamically selected via the field programmable nature of FPGA 103. Accordingly, signals may be captured during one test from pin 102E of DUT 102 (e.g., by pin 103E of FPGA 103) and such signals (or the result of processing such signals in some manner) may be output via pin 103F of FPGA 103 to logic analyzer 104. Thereafter, FPGA 103 may be re-programmed such that signals may be captured during another test from pin 102D of DUT 102 (e.g., by pin 103D of FPGA 103) and such signals (or the result of processing such signals in some manner) may be output via pin 103F of FPGA 103 to logic analyzer 104. Accordingly, pin 103F and connector 112 may be used for outputting different data during different tests depending on how FPGA 103 is programmed. This may enable full (e.g., 100%) test coverage of DUT 102, without requiring an interface for outputting all possible candidate data from DUT 102 to logic analyzer 104 at any one time. Thus, the number of interface connections to logic analyzer 104 that may be implemented on circuit board 101 may be minimized without sacrificing test coverage of DUT 102.

Further, such an implementation of FPGA 103 simplifies the routing of signals from DUT 102 to logic analyzer 104. Particularly for high pin-out DUTs (e.g., ASICs having 1,000 or more pins) that are densely populated (e.g., in a relatively small area), supplying the signals first to FPGA 103, which as described above may have pin density similar to that of the DUT 102 to enable relatively short routing distances from DUT 102 to FPGA 103, may also simplify the routing of signals to logic analyzer 104. For instance, fewer interfaces (e.g., connectors) between FPGA 103 and logic analyzer 104 may be employed on circuit board 101, as FPGA 103 may be re-programmed to use those interfaces for outputting different data (e.g., signals from different pins of DUT 102) at different times.

Additionally, FPGA 103 may include digital impedance control techniques, as are commonly included in many FPGA I/O blocks today, to enable receiver impedance to be dynamically adjusted to ensure that signal quality is not compromised, for example. The FPGA input pins can vary their input impedance to select one that is optimized to work with the net topology present in the system and minimize reflections or other adverse signal integrity phenomena that might otherwise result from the addition of the FPGA input receiver to the trace being sampled. Also, FPGA 103 handles the termination of the traces used for capturing signals when signal collection is not being performed.

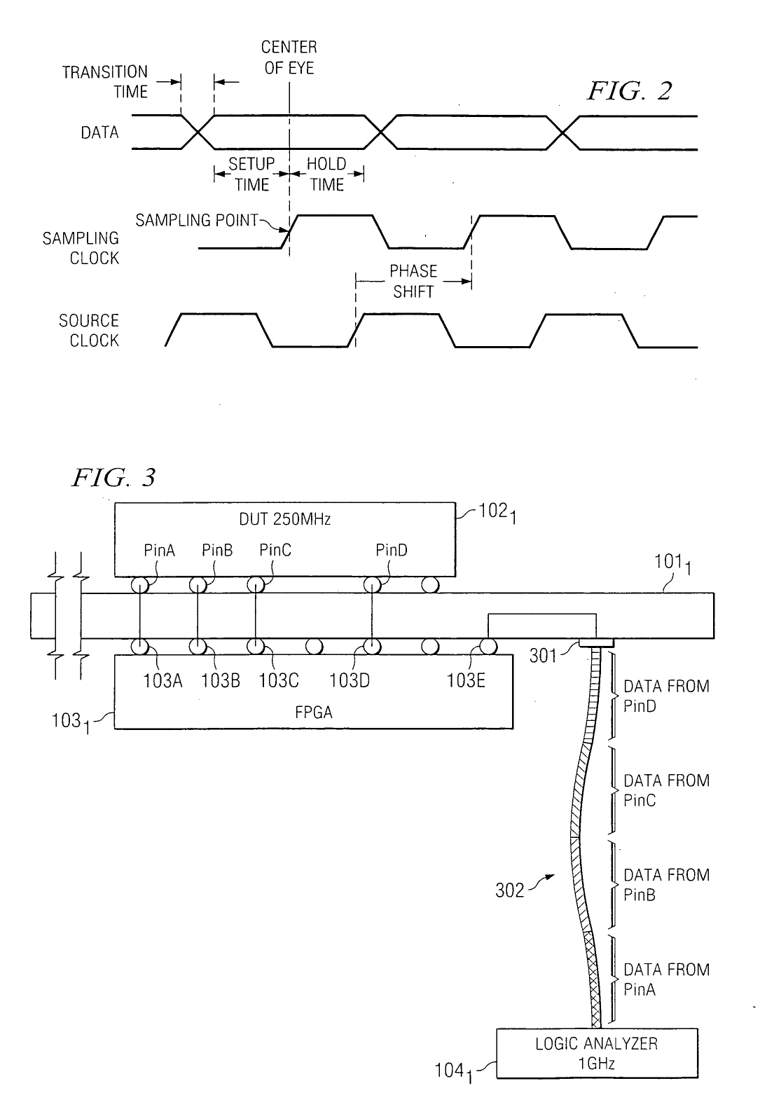

Phase shifting capabilities of FPGA 103 can also be used to adjust the data sampling point within the data eye if data corruption is suspected. As shown in FIG. 2, at the beginning of a clock cycle, there typically exists a certain period of transition time for the data signals of a DUT to stabilize, e.g., for a signal to transition to or stabilize at a given value, such as voltage high (logic 1) or voltage low (logic 0). As is well-known in the art, the logical state of signals during this transition period cannot be captured reliably. Accordingly, it is typically desirable to acquire (or capture) a data signal at a time after a device-dependant setup period has passed, but before the signal transitions again respecting the device-dependant hold time requirements, such as in the center of the data eye, as shown in FIG. 2. Again, by tuning the data sampling point of FPGA 103, data from DUT 102 may be captured within the data eye to ensure correct operation.

Such tuning may be performed, for example, by programming FPGA 103 via signals from controller 109. In one example implementation for performing such tuning, DUT 102 is controlled to output a test or fixed pattern. The phase-locked loop (PLL) is then adjusted until the fixed pattern or test pattern has a bit error rate that is the lowest of any PLL setting or statistically insignificant depending upon the application. FPGA 103 may be repeatedly loaded with a different phase shift for the PLL until the test pattern is captured as desired. This may be a one time process when first configuring the data capture system. Once the delay to be tuned into the PLL is determined it may be used on other like boards without the need to redetermine it. Alternatively, the PLL setting may be determined through simulation.

Further, FPGA 103 may perform some post-processing of signals captured from DUT 102 in certain embodiments, and the resulting processed signals may be communicated to logic analyzer 104. For instance, FPGA 103 may filter for certain desired signals of interest for a particular test and/or may provide improved logic analyzer triggering capabilities above those provided by the logic analyzer itself.

As another example, data may be provided to FPGA 103 from either controller 109 or logic analyzer 104 that specifies the output signals expected for a given input to DUT 102, and in certain embodiments FPGA 103 may perform an analysis of the captured signals from DUT 102 (e.g., to determine whether the captured output signals is as was expected responsive to the input) and FPGA 103 may communicate the “results” (e.g., an indication of pass/fail or match/mismatch) to logic analyzer 104.

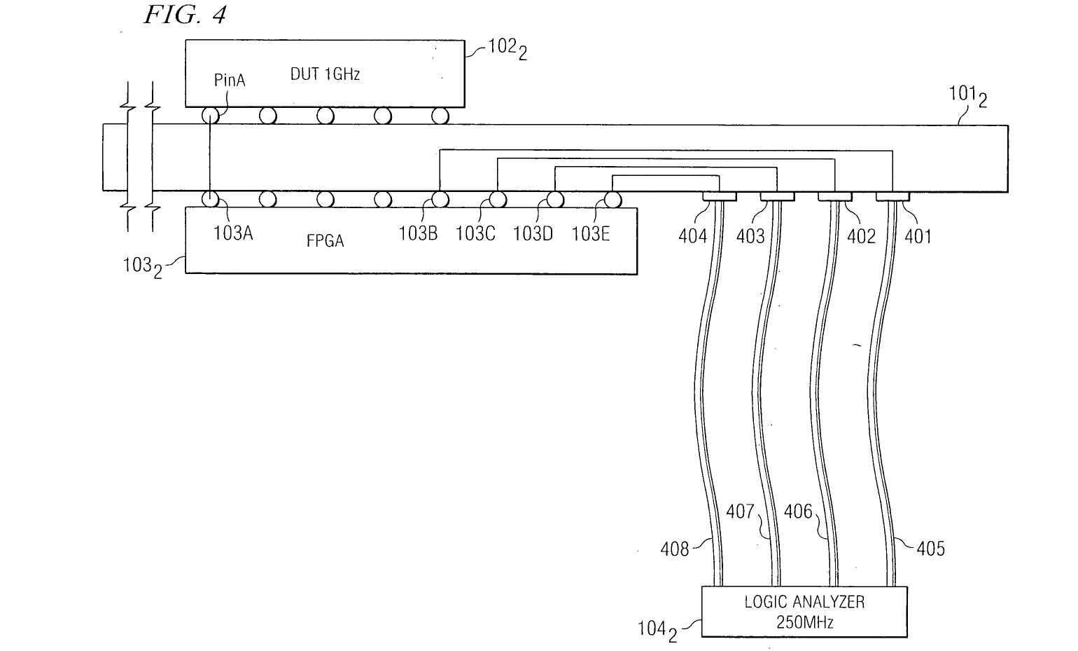

In accordance with certain embodiments, a programmable device may be utilized to capture signals of a DUT 102 at the DUT's operational speed, irrespective of the sampling frequency of the logic analyzer 104 being used to present the signals for viewing. FIGS. 3-5 show various example implementations that enable signals to be captured from a DUT and be communicated to a logic analyzer when the operational frequencies of the DUT and the logic analyzer are not the same.

Turning first to FIG. 3, an example implementation is shown in which a DUT 102₁ that operates at 250 megahertz (MHz) is included on circuit board 101₁, and such DUT 102₁ is being probed by logic analyzer 104₁ that operates at 1 gigahertz (GHz). FPGA 103₁ is implemented to capture signals from DUT 102₁ during testing, and supply such signals to logic analyzer 104₁. This embodiment takes advantage of the faster operational frequency of logic analyzer 104₁ to minimize the number of interfaces (e.g., connectors) that are employed on circuit board 101₁ for logic analyzer 104₁, as described further below. In this example, data present on pins A-D of DUT 102₁ is captured by pins 103A-103D of FPGA 103₁, respectively. Such data is serialized by FPGA 103₁ and is output via pin 103E to connector 301, which enables such data to be received by logic analyzer 104₁ via cable 302 in the manner shown. Thus, rather than requiring a separate interface (e.g., connector) for each of the signals from DUT 102₁, FPGA 103₁ may serialize the data from a plurality of different output pins for communicating it to logic analyzer 104₁ via a common interface (e.g., connector 301).

FIG. 4 shows an example implementation in which a DUT 102₂ that operates at 1 GHz is included on circuit board 101₂, and such DUT 102₂ is being probed by logic analyzer 104₂ that operates at 250 MHz. Thus, in this instance the logic analyzer is slower than the DUT. FPGA 103₂ is implemented to capture signals from DUT 102₂ during testing, and supply such signals to logic analyzer 104₂. In this embodiment, FPGA 103₂ captures data from a pin of DUT 102₂ and parallelizes such data to a plurality of different outputs such that logic analyzer 104₂ is capable of handling the rate at which such data is received. More specifically, in this example, data received from pin A of DUT 102₂ is captured by pin 103A of FPGA 103₂. Such data is divided into four separate portions (e.g., a portion corresponding to a time-slice of 250 MHz each) by FPGA 103₂ and the portions are output via pins 103B-103E, as shown. For instance, the first portion of the data received from Pin A of DUT 102₂ by FPGA 103₂ is output via pin 103B to connector 401, which enables such data to be received by logic analyzer 104₂ via cable 405. The second portion of the data received from Pin A of DUT 102₂ by FPGA 103₂ is output via pin 103C to connector 402, which enables such data to be received by logic analyzer 104₂ via cable 406, and the third portion of the data received from Pin A of DUT 102₂ by FPGA 103₂ is output via pin 103D to connector 403, which enables such data to be received by logic analyzer 104₂ via cable 407. Finally, the fourth portion of the data received from Pin A of DUT 102₂ by FPGA 103₂ is output via pin 103E to connector 404, which enables such data to be received by logic analyzer 104₂ via cable 408. Thus, DUT 102₂ may be probed at its normal operating frequency without requiring that a new, faster logic analyzer be purchased.

While the example of FIG. 4 parallelizes the data received from 1 pin of DUT 102₂ to four outputs, as described above, it utilizes four interfaces (connectors) on circuit board 101₂ for interfacing with logic analyzer 104₂. In some instances it may be desirable to reduce the number of such interfaces, and thus an implementation such as that of FIG. 5 may be utilized. FIG. 5 shows another example implementation in which a DUT 102₃ that operates at 1 GHz is included on circuit board 101₃, and such DUT 102₃ is being probed by logic analyzer 104₃ that operates at 250 MHz. Thus, as with the example of FIG. 4, the logic analyzer is slower than the DUT. FPGA 103₃ is implemented to capture data from DUT 102₃ during testing, and supply such data to logic analyzer 104₃. In this embodiment, FPGA 103₃ captures data via pin 103A from a pin, Pin A, of DUT 102₃ and outputs such data via pin 103B to connector 501. Another device, such as FPGA 503, that is external to circuit board 101₃ interfaces with connector 501 (e.g., via cable 502) to receive the data from FPGA 1033. Such FPGA 503 may parallelize the received data to a plurality of different outputs such that logic analyzer 104₃ is capable of handling the rate at which such data is received. More specifically, in this example, the output data from FPGA 103₃ is received by external FPGA 503, and such data is divided into four separate portions (e.g., a portion corresponding to a time-slice of 250 MHz each) by FPGA 503, which may be communicated via parallel communications (e.g., cables) 504, 505, 506, and 507 to logic analyzer 104₃, as shown. Thus, DUT 102₃ may be probed at its normal operating frequency without requiring that a new, faster logic analyzer be purchased, and the number of interfaces (e.g., connector 501) implemented on circuit board 101₃ is minimized.

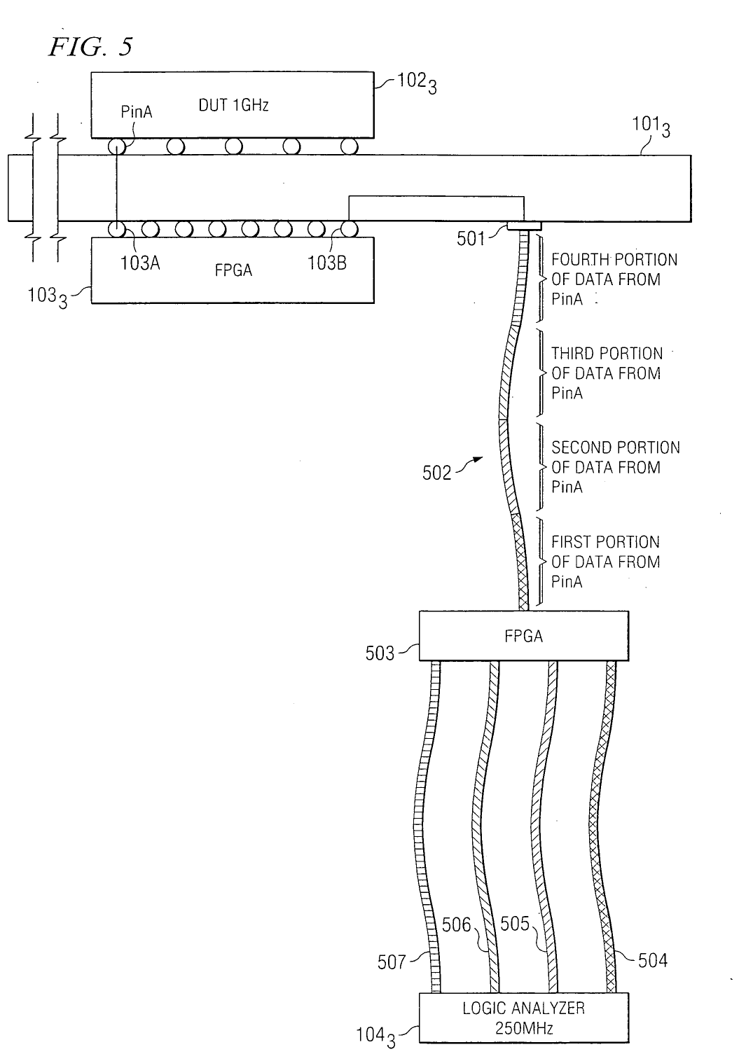

In certain embodiments, FPGA 103 may be implemented to capture data on both the rising and falling edges of a clock signal, which is commonly referred to as “double-pumping”. An example implementation of such an FPGA 103 is shown in FIG. 6. As shown, FPGA 103₄ may be implemented to capture data from Pin A of DUT 102₄ arranged on circuit board 101₄. More specifically, FPGA 103₄ may receive data from Pin A at pin 103A. Also, a clock signal, shown as CLK, is received by Pin 103B of FPGA 103₄ from Pin B of DUT 102₄. Two flip-flops 601 and 602 may be implemented to enable data to be captured through pin 103A on each rising and falling edge of CLK. For instance, on a positive-going transition (rising edge) of CLK, flip-flop 601 captures (or latches) data from pin 103A, and on a negative-going transition (falling edge) of CLK, flip-flop 602 captures data from pin 103A. Thus, FPGA 103₄ has the ability to sample data at a high rate by using the two flip-flops 601 and 602 to capture data from DUT 102₄ on both falling and rising edges of CLK. This implementation may increase the effective sampling rate of the analysis system beyond that available from the logic analyzer supplier.

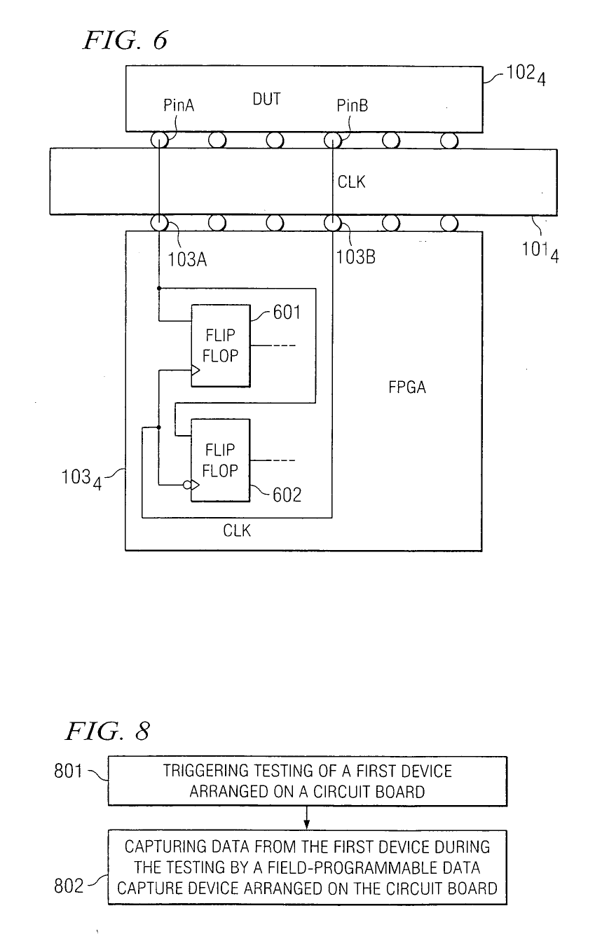

Turning now to FIG. 7, an example operational flow diagram of an embodiment for capturing signals from a DUT is shown. In operational block 701, a capture device (e.g., FPGA) is implemented on a circuit board with a device to be tested (DUT). As described above, the capture device may be arranged such that signals present at the DUT travel only a short distance before being received by the capture device. Further, in certain implementations, as when the DUT is a high-density, high pin-out device, the capture device implemented may comprise pins that are arranged similar to those of the DUT. In operational block 702, the capture device of the illustrated embodiment is programmed to capture at least a portion of the desired data from the DUT during testing. For instance, the capture device is programmed to select its input pins that are to be used for receiving data and/or to select its output pins that are to be used in block 705 below for communicating that data to a logic analyzer.

In operational block 703, data from one or more pins of the DUT is received through corresponding pins of the capture device. In operational block 704, the capture device may, in certain implementations, process the captured output data in some way (e.g., invert it, compare it with expected data patterns to determine if a match is achieved, filter it, etc.). And, in operational block 705, the programmable capture device communicates to a logic analyzer (e.g., via one or more of the capture device's output pins) the captured data from the DUT and/or the data resulting from processing (in block 704) of the captured output data.

In operational block 706, a determination is made whether testing is complete. If it is not complete, then operation advances to block 708 whereat it is determined whether to reconfigure the capture device to select different data to capture from the DUT and/or to select different data to output from the capture device to the logic analyzer. If such a reconfiguration is not desired, operation returns to block 703 to continue capturing data from the DUT (e.g., responsive to further input data to the DUT). If reconfiguration of the capture device is desired in block 708, then operation advances to block 709 whereat the capture device is re-programmed as desired. Thereafter, operation returns to block 703 to continue capturing data from the DUT. Operation continues until it is determined in block 706 that probing is complete, wherein operation ends in block 707.

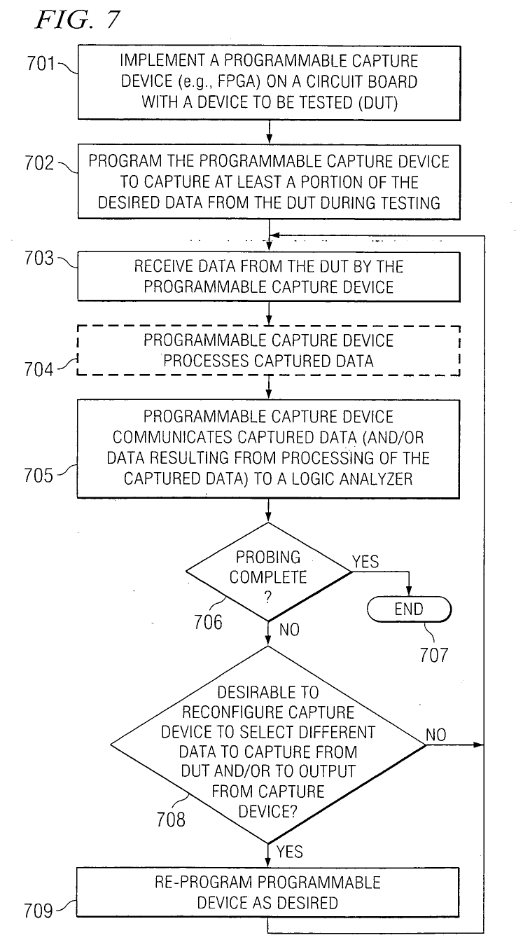

FIG. 8 shows another example operational flow diagram of an embodiment for capturing signals from a DUT. As shown, testing of a first device arranged on a circuit board is triggered in block 801. And, in block 802, data (or “signals”) from the first device is captured during the testing by a capture device arranged on the circuit board.

In view of the above, certain embodiments described herein implement a capture device for capturing and buffering signals during probing of a DUT. Such capture device may be arranged on a circuit board relatively close to the output pins of the DUT such that signal quality is not significantly degraded. Further, in certain embodiments, the DUT may operate at its normal operating frequency during probing, irrespective of the operational frequency of a logic analyzer being used for probing the DUT. The signals from one or more pins of the DUT are buffered (e.g., temporarily stored) in the capture device. In certain embodiments, the captured signals can be output from the capture device to a logic analyzer (e.g., via an interface, such as a connector on the circuit board) at frequencies substantially lower than that at which the DUT itself operates. In certain embodiments, the capture device may perform some analysis or other operation on the captured DUT signals states, and the results of such processing by a capture device may be output to the logic analyzer. For instance, in certain embodiments, the capture device may be programmed to perform an analysis of the captured data to determine whether it matches expected values and the capture device may communicate to the logic analyzer an indication of whether the captured data met expectations. According to certain embodiments, the capture device is capable of being programmed for more complex triggering scenarios than are natively available on the logic analyzer itself. This greatly enhances the ability to identify and debug malfunctioning elements of the circuit that could occur infrequently. The programmability of the capture device lends itself well to adaptive data filtering and formatting that logic analyzers are unable to provide.

In certain embodiments, the capture device is field programmable such that its operation may be varied after it is placed on the circuit board. For example, the capture device may be reprogrammed to capture signals from different pins of the DUT. In certain embodiments, a FPGA is implemented as the capture device for the DUT. The FPGA may be arranged relatively close to the signal pins of the DUT. For example, in one implementation, an FPGA is arranged on the opposite side of a circuit board from a DUT. The pins of the FPGA may correspond nicely to the pins of the DUT, thus enabling data to be routed a relatively short distance from the DUT to the FPGA. Additionally, such an implementation of an FPGA may simplify the routing of signals from pins of a DUT (particularly a high pin-out DUT) for capture of this data by the FPGA. The captured data (or the data resulting from post-processing of the captured data by the FPGA) may be routed from the FPGA to one or more interface points (e.g., connectors) arranged on the circuit board for interfacing with the logic analyzer. Because these logic analyzer connectors do not directly interface with the DUT, they can be placed at substantially greater distances than prior testing techniques allowed because the deleterious effects on signal quality of such placement does not impede DUT circuit performance.

1. A system comprising:
a first device arranged on a circuit board; and
a programmable capture device arranged on said circuit board, wherein at least one input pin of said programmable capture device is communicatively coupled to at least one signal pin of said first device such that said programmable capture device captures at least one signal from said first device during testing of said first device.

2. The system of claim 1 wherein said first device is arranged on a first side of said circuit board, and wherein said programmable capture device is arranged on a side of said circuit board opposite said first side.

3. The system of claim 2 wherein said programmable capture device comprises pins having an arrangement corresponding to an arrangement of pins of the first device.

4. The system of claim 3 wherein said first device comprises at least one-thousand signal pins.

5. The system of claim 1 wherein said programmable capture device has a density of input pins on the order of signal pins of said first device.

6. The system of claim 5 wherein said first device comprises at least one-thousand signal pins.

7. The system of claim 1 wherein said first device comprises an Application-Specific Integrated Circuit (ASIC).

8. The system of claim 1 wherein said programmable capture device comprises a Field Programmable Gate Array (FPGA).

9. The system of claim 1 further comprising:
at least one output pin of said programmable capture device communicatively coupled to an interface for a logic analyzer that is external to said circuit board, wherein said interface is arranged on said circuit board.

10. The system of claim 9 wherein said testing of said first device comprises testing said first device at its normal operating frequency.

11. The system of claim 10 wherein said logic analyzer has an operational frequency slower than the normal operating frequency of said first device, and wherein said programmable capture device buffers captured signals from the first device and outputs the captured signals at a frequency supported by the logic analyzer.

12. The system of claim 11 wherein the programmable capture device parallelizes the captured signals.

13. The system of claim 10 wherein said logic analyzer has an operational frequency greater than the normal operating frequency of said first device, and wherein said programmable capture device buffers captured signals from the first device and outputs the captured signals at a frequency supported by the logic analyzer.

14. The system of claim 13 wherein the programmable capture device serializes the captured signals.

15. A method comprising:
triggering testing of a first device arranged on a circuit board; and
capturing data from said first device during said testing by a field-programmable data capture device arranged on said circuit board.

16. The method of claim 15 further comprising:
outputting at least a portion of the captured data from the field-programmable data capture device to a logic analyzer arranged external to said circuit board.

17. The method of claim 15 further comprising:
programming the field-programmable data capture device to capture desired data from the first device.

18. The method of claim 17 wherein said programming comprises:
programming the field-programmable data capture device while said field-programmable data capture device is arranged on said circuit board.

19. The method of claim 17 further comprising:
communicatively coupling a control system to said field-programmable data capture device arranged on said circuit board for performing the programming.

20. The method of claim 17 wherein the programming comprises selecting at least one signal pin of said first device from which data is to be captured by said field-programmable data capture device.

21. A system comprising:
a first means for performing an operation, wherein said first means is arranged on a circuit board; and
a means, arranged on said circuit board, for capturing signals from said first means during testing of said first means, wherein the capturing means is programmable while arranged on said circuit board.

22. The system of claim 21 further comprising:
a means, arranged external to said circuit board, for analyzing captured signals of the first means, wherein the analyzing means is communicatively coupled to the capturing means.

23. The system of claim 21 further comprising:
means, arranged external to said circuit board, for programming the capturing means.

24. The system of claim 23 wherein the programming comprises selecting at least one signal pin of the first means from which signals are to be captured by the capturing means.

25. The system of claim 21 wherein the capturing means comprises a plurality of input pins that are each communicatively coupled to a different signal pin of the first means, and wherein the capturing means is programmable to select at least one of said input pins that is to have its received signals output at an output pin of the capturing means.
